(19) United States
(12) Patent Application Publication
(10) Pub. No.: US 2016/0205157 A1
(43) Pub. Date: Jul. 14, 2016

(54) BROADCASTING IN COMMUNICATION NETWORKS

(71) Applicant: Alcatel-Lucent USA Inc., Murray Hill, NJ (US)

(72) Inventors: Thomas P. Chu, Englishtown, NJ (US); Young Kim, Basking Ridge, NJ (US); Marina Thottan, Westfield, NJ (US)

(73) Assignee: Alcatel-Lucent USA Inc., Murray Hill, NJ (US)

(21) Appl. No.: 13/851,622

(22) Filed: Mar. 27, 2013

(51) Int. Cl. H04L 29/06; H04L 12/707; H04L 12/26; H04L 12/46; H04L 12/733

(52) U.S. Cl. CPC H04L 65/4076; H04L 12/4633; H04L 45/122; H04L 43/0847; H04L 45/22

(57) ABSTRACT

In one embodiment, a first node is adapted for communication with a plurality of additional nodes of a communication network, such as a Delaunay Triangulation (DT) network. The first node is configured to detect a failure in delivery of a broadcast packet to at least a given one of the additional nodes. Responsive to the detected failure in delivery of the broadcast packet to the given additional node, the first node encapsulates the broadcast packet in a unicast packet for delivery to a downstream node of the given additional node. The first node may be configured to detect the failure in delivery of the broadcast packet to the given additional node using a hop level acknowledgment process. Other embodiments are configured to facilitate implementation of progressive search by communicating identifiers from boundary nodes of the network that are reached in a given stage of the progressive search.

### FIELD

The field relates generally to communication networks, and more particularly to techniques for broadcasting packets or other information in such networks.

### BACKGROUND

Broadcasting techniques are commonly used to distribute packets or other information throughout a communication network. For example, in client-server networks, a server node may want to broadcast its identity over the network so that client nodes are aware of its location. As another example, in hierarchical networks, a node belonging to a higher layer may want to broadcast its location to other nodes in a base layer. More generally, broadcast is an effective mechanism for a given network node to inform other network nodes of information associated with the given node, such as its identity and location, as well as capabilities or services that it provides. Broadcast techniques are also often used to allow a given network node to search for other network nodes that provide capabilities or services needed by the given node.

### SUMMARY

Illustrative embodiments of the present invention provide enhanced broadcasting functionality implemented in nodes of a communication network.

In one embodiment, a first node is adapted for communication with a plurality of additional nodes of a communication network, such as a Delaunay Triangulation (DT) network. The first node is configured to detect a failure in delivery of a broadcast packet to at least a given one of the additional nodes. Responsive to the detected failure in delivery of the broadcast packet to the given additional node, the first node encapsulates the broadcast packet in a unicast packet for delivery to another one of the additional nodes that is a downstream node of the given additional node. The unicast packet is then sent to the downstream node. Each of the additional nodes including the downstream node may be configured in substantially the same manner as the first node.

The first node may be configured to detect the failure in delivery of the broadcast packet to the given additional node using a hop level acknowledgment process. For example, in accordance with one such hop level acknowledgement process, the broadcast packet may comprise a header that includes a hop level acknowledgement indicator. The hop level acknowledgment indicator of the broadcast packet header may comprise a binary indicator having a first value indicating that hop level acknowledgment is activated for the broadcast packet and a second value indicating that hop level acknowledgment is not activated for the broadcast packet.

The first node may be configured to maintain neighbor information identifying each of the additional nodes that is a neighbor of the first node as well as each of the additional nodes that is a neighbor of one of the neighbors of the first node. This neighbor information is utilized by the first node to identify one or more downstream nodes of the given additional node to which the broadcast packet will be sent encapsulated in a unicast packet upon detection of the failure in delivery of the broadcast packet to the given additional node. For example, responsive to the detected failure in delivery of the broadcast packet to the given additional node, the first node may utilize the neighbor information to identify all of the neighbors of the given additional node that are not also a neighbor of the first node and are further away from a source node of the broadcast packet than the given additional node. The first node then sends to each of the identified nodes the broadcast packet encapsulated in a unicast packet.

Other embodiments are configured to facilitate implementation of progressive search by communicating identifiers from boundary nodes of the network that are reached in a given stage of the progressive search. For example, the first node referred to above may be additionally or alternatively configured such that if the first node receives from one of the additional nodes that is an upstream node of the first node a broadcast packet containing a search message or otherwise associated with a search and having a hop count indicating that a hop count limitation has been reached, the first node generates a response for delivery back to the upstream node that includes information identifying the first node as a boundary node of the search. The response may comprise a unicast packet having as its destination a source node of the search. The boundary node identifying information received by the source node is used to facilitate one or more subsequent stages of the progressive search. For example, the source node can identify a subset of the boundary nodes and request that each of those boundary nodes execute a search with a specified hop count limitation as part of the subsequent stage of the progressive search.

A given node of the communication network may comprise a network device such as a router, switch, server, computer or other processing device implemented within the communication network.

### BRIEF DESCRIPTION OF THE DRAWINGS

FIGS. 1a and 1b show respective examples of a DT communication network and a non-DT communication network, each comprising nodes configured in accordance with an illustrative embodiment of the invention.

FIG. 2 illustrates the operation of an exemplary greedy forwarding algorithm implemented in a DT network.

FIG. 3 illustrates the operation of an exemplary reverse path forwarding (RPF) algorithm implemented in a DT network.

FIG. 4 illustrates an exemplary failure recovery process initiated responsive to a detected failure in delivery of a broadcast packet.

FIG. 5 shows an example of a 3-hop search in an initial stage of a progressive search in a DT network.

FIG. 6 shows an example of a possible subsequent stage of the progressive search having the initial stage shown in FIG. 5.

FIG. 7 is a block diagram of a node of a DT network in one embodiment.

### DETAILED DESCRIPTION

Illustrative embodiments of the invention will be described herein with reference to exemplary communication networks, network nodes and associated broadcasting techniques. It should be understood, however, that the invention is not limited to use with the particular arrangements described, but is instead more generally applicable to any communication network application in which it is desirable to provide enhanced broadcasting functionality relative to conventional arrangements.

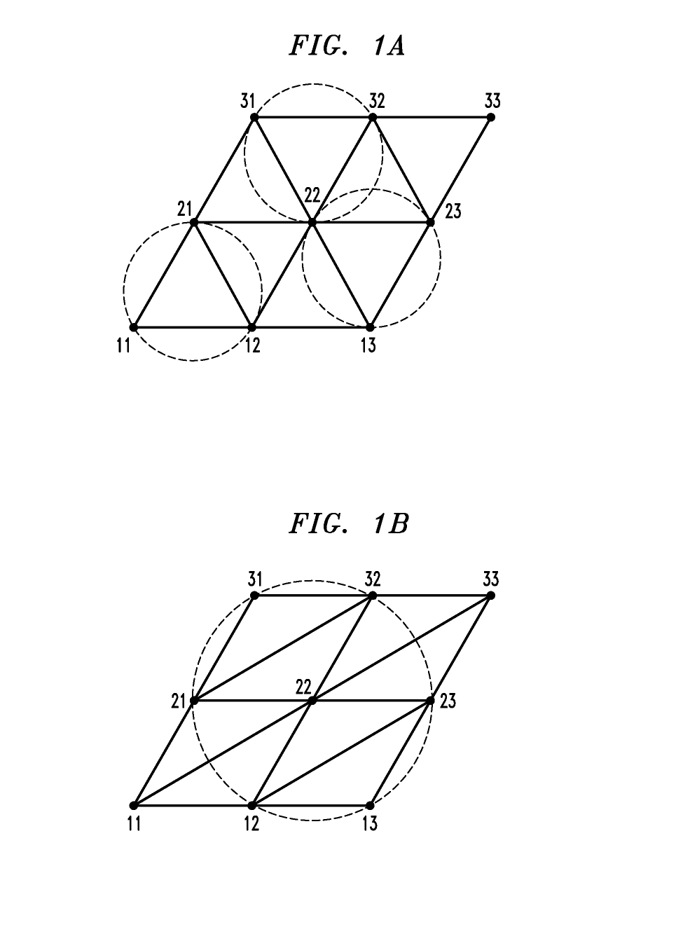

FIGS. 1a and 1b show examples of communication networks that are configured to implement broadcasting techniques in accordance with respective illustrative embodiments of the invention. Each of these networks comprises a set of nine interconnected nodes denoted 11, 12, 13, 21, 22, 23, 31, 32 and 33.

It is assumed that each such node corresponds to a separate network device. The network devices may comprise routers, switches, servers, computers or other processing devices, in any combination. A given network device will generally comprise a processor and a memory coupled to the processor, as well as one or more transceivers or other types of network interface circuitry which allow the network device to communicate with the other network devices to which it is interconnected.

As will be described in greater detail below, the nodes of the communication networks of FIGS. 1a and 1b are configured to implement enhanced broadcasting functionality.

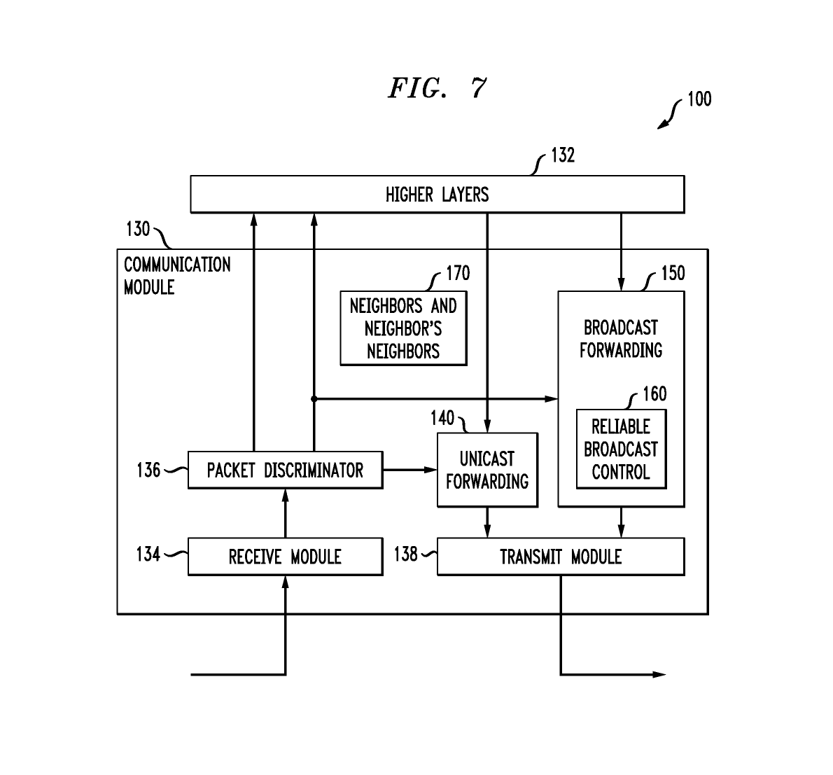

One possible embodiment of a network node with enhanced broadcasting functionality will be described herein in conjunction with FIG. 7, and one or more of the nodes of the networks of FIGS. 1a and 1b are each assumed to be configured in the manner illustrated in FIG. 7.

The nodes may be configured to communicate with one another using wired or wireless communication protocols, as well as combinations of multiple wired or wireless protocols. Furthermore, although fixed nodes are assumed in one or more of the embodiments, it is possible in other embodiments that at least a subset of the nodes may be mobile. Various combinations of fixed and mobile nodes may be used in a given network, while other networks may comprise all fixed nodes or all mobile nodes.

Accordingly, each of the nodes in a given one of the networks may be configured in substantially the same manner, or different configurations may be used for different subsets of the nodes within a given network.

The communication network of FIG. 1 a is an example of what is more generally referred to herein as a Delaunay Triangulation (DT) network. A DT network may comprise a peer-to-peer network of the type commonly used in large scale networks such as smart-grid networks. Numerous other types of DT networks may be used in embodiments of the invention.

Given a set of nodes in a two-dimensional space, a triangulation network may be formed by connecting the nodes so that the resulting network comprises non-overlapping triangles. DT refers to a triangulation in which each such triangle can be associated with a circumscribing circle that does not include any node other nodes corresponding to respective vertices of the triangle.

With reference to FIG. 1a, three exemplary circumscribing circles are shown for respective non-overlapping triangles of the DT network. It can be seen that each such circle includes only the vertex nodes of its corresponding triangle. For example, the circle for the triangle comprising nodes 11, 12 and 21 does not include any nodes other than these three nodes. Similar observations can be made for the other non-overlapping triangles in this exemplary DT network.

With reference to FIG. 1b, this exemplary network includes the same nine nodes as the DT network of FIG. 1a, but the nodes are interconnected in accordance with a different triangulation. A circumscribing circle is shown for a given triangle that includes as its vertices the nodes 21, 31 and 32. It is readily apparent that this circle includes additional nodes, such as nodes 12, 13 and 23. Accordingly, the triangulation shown in FIG. 1b results in a non-DT network.

Embodiments of the invention can be implemented in a variety of different types of DT and non-DT networks. However, for simplicity and clarity of further description, it will be assumed that the disclosed broadcasting techniques are implemented in a two-dimensional DT network of the type shown in FIG. 1a.

It should also be noted in this regard that a DT network as that term is broadly used herein may be implemented as a hierarchical DT network having a base layer and one or more higher layers. The techniques disclosed herein in the context of two-dimensional DT networks having a single layer of nodes can therefore be extended in a straightforward manner to hierarchical DT networks.

A given DT network may be implemented such that each node is administratively configured to include the identities of its neighbors upon initialization of the network. Additionally or alternatively, various automated protocols may be used to configure a given DT network. Examples of such automated protocols are described in D.-Y. Lee and S. S. Lam, “Protocol Design for Dynamic Delaunay Triangulation,” Proceedings of the 27^{th} International Conference on Distributed Systems, 2007, IEEE, which is incorporated by reference herein.

In some embodiments, a maintenance protocol is used between neighboring nodes to detect failures. Through use of such a maintenance protocol, a given node A can send to one of its neighboring nodes B the identities of the other neighboring nodes of node A. Accordingly, a given DT network node can learn the identities of the neighbors of all of its neighbors. Certain embodiments described below will assume the use of such a maintenance protocol, although other embodiments may use other types of protocols or alternative arrangements for this purpose.

A given DT network in some embodiments may also be configured such that the location coordinates of a particular network node can be extracted from its identity, as expressed by an identifier or ID. This feature allows distances between two nodes to be computed if their respective identities are known. The notation d(u,v) will be used herein to denote the distance between two nodes u and v.

One advantage of a DT network is that a so-called “greedy” forwarding algorithm is guaranteed to work in forwarding unicast packets, such that there is no risk of a packet being trapped at a local optimal point. In an exemplary implementation of a greedy forwarding algorithm, when a given node needs to forward a packet, it will determine, among all of its neighbors, the neighboring node that is closest to the destination, and will forward the packet to this node.

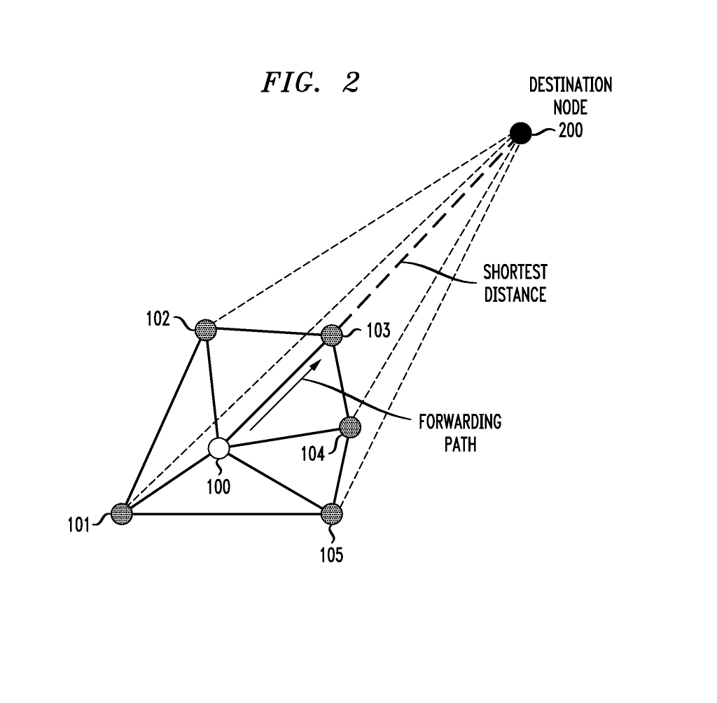

FIG. 2 illustrates the operation of the above-noted exemplary greedy forwarding algorithm in a DT network. The portion of the DT network shown includes nodes 100, 101, 102, 103, 104 and 105, and a destination node 200. It is assumed that node 100 wants to forward a packet to destination node 200. The packet to be forwarded may be a packet that originates from node 100 or a packet that node 100 receives from one of its neighbors. Node 100 has five neighbors, namely, the nodes 101, 102, 203, 104 and 105, with node 103 having the shortest distance of the five neighbors to the destination node 200, as indicated in the figure. Therefore, in accordance with the exemplary greedy forwarding algorithm as previously described, node 100 forwards the packet to node 103 along the forwarding path as shown.

The use of a greedy forwarding algorithm of the type described above avoids the need for a given node to maintain a large forwarding table. Also, the node does not require a routing protocol to acquire the topology of the network.

Another advantage of a DT network is that each node in the DT network only needs to support a relatively small number of connections to other nodes. For example, in a given two-dimensional DT network of the type illustrated in FIG. 1a, each node in the network will have at most six such connections, and thus at most six neighboring nodes.

It should be noted that a DT network may be implemented as an overlay network over a transport network such as an Internet protocol (IP) network. Thus, the connections between neighboring nodes in the figures may be logical connections implemented using an underlying transport network. The term “link” as used herein is intended to be broadly construed so as to encompass such logical connections. These logical connections and other types of links between nodes as illustrated herein may be considered examples of what are more generally referred to herein as “hop level” arrangements.

Due to their ability to use simple forwarding mechanisms as well as their low connection requirements, DT networks are particularly well-suited for use in network applications involving large numbers of simple nodes. These may comprise, for example, machine-to-machine networks in which at least a subset of the nodes comprise respective sensors or other types of data collectors, while other nodes comprise associated controllers. The data collectors and controllers are usually implemented as simple devices that are designed to do a few specific tasks. The above-noted smart-grid network is a more particular example of a machine-to-machine network, although it should be appreciated that a wide variety of other types of machine-to-machine networks, as well as other numerous other alternative network types, may be used in implementing embodiments of the present invention.

DT networks in embodiments of the present invention may be configured to implement a variety of different broadcast algorithms. For example, an exemplary flooding algorithm may be implemented as follows:

1. A source node will forward a packet to all of its neighbors.

2. When a node receives a broadcast packet, it will forward the packet to all of its neighbors except the one from which it received the packet.

When using a flooding algorithm, precautions should be taken to reduce the number of duplicate packets in the network and to prevent loops. One way to do this is to include the following information in the header of a broadcast packet:

1. An indicator that the packet is a broadcast packet.

2. The identity of the source node.

3. A packet identifier or ID assigned by the source node that, together with the node ID, uniquely identifies the packet.

4. A counter that is decremented by one when a node receives the packet from another node. When this counter reaches 0, the packet will be discarded.

Instead of a counter that decrements at each hop, as in item 4 above, other embodiments may utilize a counter that is initialized at 0 and increments at each hop. An additional parameter which indicates the maximum hop count would also be present in the header. A node would not forward a broadcast packet if the value of the counter reaches the maximum hop count. It should therefore be appreciated that any embodiments described herein with reference to decrementing hop counters may instead be implemented using incrementing hop counters.

Each node is assumed to maintain its own internal database of received broadcast packets. When a node receives a given packet from one of its neighbors, it will first check whether it has received the given packet before by checking its database. If it has already received the given packet, it will just discard the given packet. If it has not already received the given packet, it will store the header information of the given packet in its database and then forward the given packet to all neighbors other than the one from which the given packet was received.

The flooding algorithm described above is inefficient in that a broadcast packet will be transmitted over each link of network at least once. A more efficient algorithm is to use a tree to distribute the broadcast packet. An example of a protocol of this type is a reverse path forwarding (RPF) algorithm.

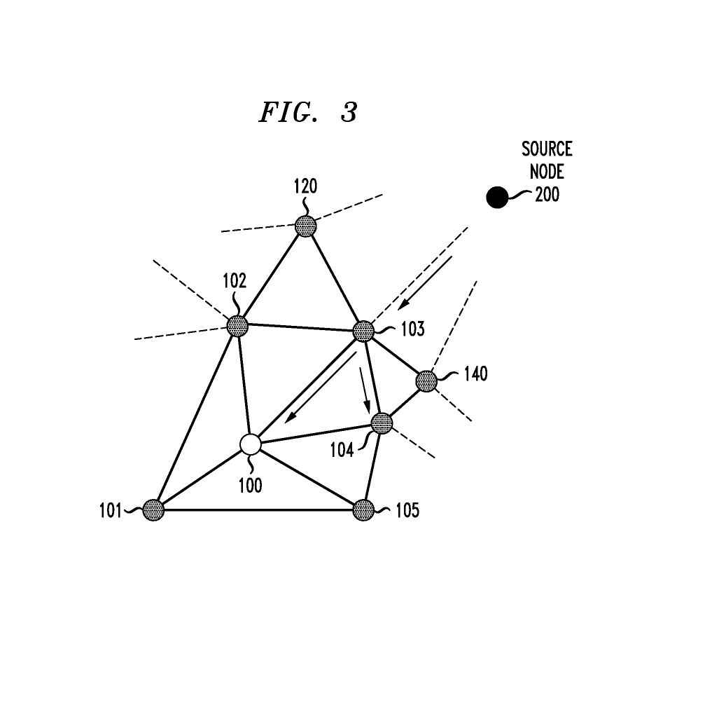

FIG. 3 illustrates the operation of an exemplary RPF algorithm implemented in a DT network. In this exemplary RPF algorithm, a broadcast packet is forwarded from a source node s to another node t along the same path that t sends regular unicast packets to s, but in the reverse direction. It will also be assumed that, as mentioned previously, there is a maintenance protocol between the nodes such that each node can learn the identities of the neighbors of all of its neighbors.

With this assumption, the exemplary RPF algorithm may be implemented in the following manner. When a node u receives a broadcast packet with source address s, u will forward the packet to a neighbor v if:

1. The node u is no further from s than v is from s, i.e. d(u,s)≦d(v,s); and

2. The node u is no further from s than any neighbor of v is from s, i.e. d(u,s)≦d(w,s) for all w where w is a neighbor of v. If there is some neighbor of v, denoted w, that is closer to s than u, then v will forward regular unicast packets to w rather than u, such that u would not be on the forwarding path from v to s, and v would not be on the reverse path of u from s. Thus, u does not need to forward the packet to v.

Referring now more particularly to the diagram of FIG. 3, node 103 receives a broadcast packet forwarded from a source node 200. In accordance with the above-described RPF algorithm, node 103 will forward the broadcast packet to node 100 as indicated, because node 103 is closer to source node 200 than node 100, and all the other neighbors of node 100, namely nodes 101, 102, 104 and 105, are further away from node 200 than node 103 is from node 200. Similarly, node 103 also forwards the packet to node 104 as indicated. However, node 103 will not forward the packet to node 120 as node 120 is closer to 200 than node 103. It will also not forward the packet to node 102 as one of the neighbors of node 102, node 120, is closer to node 200 than node 103.

With this exemplary RPF algorithm, the number of links that are used by a broadcast packet is substantially reduced. However, this efficiency comes at a cost in terms of reduced robustness to failure, in that if a link on an RPF tree fails, a portion of the network may not receive the packet.

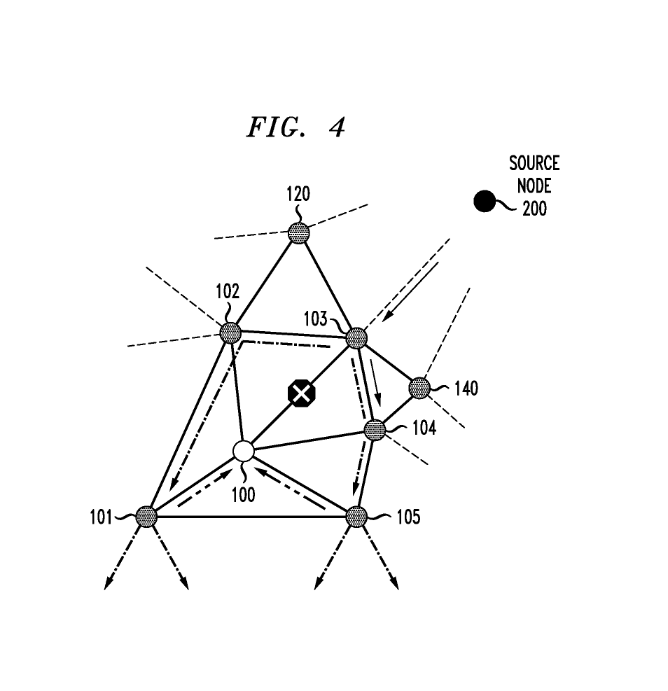

The embodiment of FIG. 4 overcomes this significant drawback of the RPF algorithm illustrated in FIG. 3. In the FIG. 4 embodiment, the network nodes are configured to use a hop level acknowledgement process to confirm the delivery of a packet to a next hop on a path. If a failure to deliver the packet to the next hop is detected, a failure recovery process to bypass the failed link or node is carried out.

This advantageous hop level acknowledgment process may be implemented, for example, by including in a header of a broadcast packet an indicator that specifies whether or not hop level acknowledgment is activated for that packet. The indicator in this example is therefore a binary indicator, having two possible logic values, which may be referred to herein as ON and OFF. If the indicator is set to ON, then hop level acknowledgement is activated for this packet. If the indicator is set to OFF, the packet will be forwarded as described before without any enhanced functionality.

Assuming hop level acknowledgement is activated for a given broadcast packet, when node u forwards that broadcast packet to node v, it will start a timer and wait for an acknowledgement from node v. If an acknowledgement is received from v before the timer expires, the packet has been delivered successfully and the hop level acknowledgement process terminates. If the timer expires before an acknowledgement is received, node u will resend the packet to v, restart the timer, and wait for the hop level acknowledgement. If there is still no acknowledgement from v after a designated number of tries, then it is likely that either node v or the connection to node v is down. Node u will then initiate the failure recovery process.

An exemplary implementation of the failure recovery process is as follows. Node u will first identify all the neighbors of v that are not also a neighbor of node u, and are further away from source node s then v. The identified nodes are denoted w₁, w₂, . . . , etc. Node u will then encapsulate the broadcast packet in a special delivery unicast packet and forward the special delivery unicast packet to each of these identified nodes. The special delivery unicast packet is an example of what is more generally referred to herein as simply a “unicast packet.” Also, the term “encapsulating” as used herein in the context of encapsulating a broadcast packet in a unicast packet is intended to be broadly construed, so as to encompass a wide variety of different arrangements for incorporating all or a substantial portion of one packet into another packet.

When forwarding the special delivery unicast packet, node v is ignored in the determination of the forwarding path. The header of the special delivery unicast packet includes the following information:

1. An indicator that a broadcast packet is encapsulated in the special delivery unicast packet.

2. An instruction that, upon receipt of the special delivery unicast packet, the special delivery unicast packet should be delivered to node v.

Upon receipt of the above-described special delivery unicast packet, node wᵢ de-encapsulates the broadcast packet and proceeds to forward this broadcast packet along the appropriate RPF tree as described previously. At the same time, node wᵢ would also send the special delivery unicast packet containing the broadcast packet to node v.

FIG. 4 illustrates this exemplary failure recovery process as initiated responsive to a failure in delivering a broadcast packet. It is assumed that the failure is detected using the hop level acknowledgement process. The network shown in FIG. 4 includes the same arrangement of nodes as previously described in conjunction with FIG. 3, but these nodes are now assumed to be configured with enhanced broadcasting functionality, including capabilities for executing the above-described processes for hop level acknowledgement failure recovery.

In the FIG. 4 embodiment, node 103 receives a broadcast packet as forwarded from source node 200. As described in conjunction with FIG. 3, absent any link or node failure, node 103 would ordinarily forward the broadcast packet to node 100 and node 102. However, in this example, it is assumed that the connection between node 103 and node 100 is down.

When node 103 detects a failure in the delivery of the packet to node 100, it will encapsulate the broadcast packet in the above-described special delivery unicast packet and forward the special delivery unicast packet to nodes 101 and 105 as they are not neighbors of node 103 and they are further away from node 200 than node 100. Nodes 102 and 104 are not selected as they are neighbors of node 103.

When node 101 or node 105 receives the special delivery unicast packet, it de-encapsulates the broadcast packet and forwards the broadcast packet downstream along the appropriate RPF tree as described previously. Node 101 or node 105 would also forward the received special delivery unicast packet to node 100.

In this example, node 103 detects the failure of delivery to node 100 using the hop level acknowledgement process, and therefore removes node 100 from consideration for further forwarding. The special delivery unicast packet is forwarded to nodes 102 and 105, and the broadcast packet is forwarded to node 104. It is likely that node 104 would also forward the broadcast packet to node 105 in accordance with the RPF algorithm. It is therefore possible for a neighboring node of the node 100 to receive the broadcast packet twice, once as a normal broadcast packet and once encapsulated in the special delivery unicast packet.

Since each node is assumed to store the header information of all received broadcast packets, a node can determine whether it has already received a given broadcast packet, and the duplicated broadcast packet will not be forwarded the second time. However, the special delivery unicast packet will still be forwarded to node 100 as described previously.

Upon the receipt of the special delivery unicast packet from node 101 or node 105, node 100 de-encapsulates the broadcast packet and forwards the broadcast packet normally as specified by the RPF algorithm. The exception is that node 100 does not need to forward the broadcast packet to the node(s) from which it received the special delivery unicast packet. In the FIG. 4 example, node 100 does not need to forward the broadcast packet to nodes 101 and 105, since node 101 and node 105 are all the downstream nodes of node 100 for a broadcast packet originating from source node 200. Also, node 100 in this example does not need to forward the broadcast packet to any node.

As mentioned previously, broadcast is an effective mechanism for a given network node to inform other network nodes of information associated with the given node, such as its identity and location, as well as capabilities and services that it provides. Broadcast techniques are also often used to allow a given network node to search for other network nodes that provide capabilities or services needed by the given node.

For example, a source node may perform a progressive search in order to locate one or more other nodes that support a particular service. Such services may include IPv4-IPv6 conversion, data collection, or dispatching services, as well as a wide variety of other types of services.

A progressive search is generally carried out in stages, so as to limit the number of packets that are sent as part of the search. Initially, the source node only executes the search over a portion of the network. If the search fails to locate another node that supports the desired service, the source node would then search for the service in another portion of the network. This process repeats until a node supporting the desired service is located or the entire network has been searched. Embodiments of the invention provide enhanced techniques for implementing these and other types of progressive searches in a DT network.

In some embodiments, a progressive search is defined at least in part using one or more hop count limitations. The nodes at which a given stage of a progressive search will not go any further because a hop count has been reached for that stage are referred to herein as boundary nodes. These embodiments may be configured such that each of the boundary nodes of a given stage of a progressive search reports its identity to an upstream node even if it also reports a negative response. This information can be used by the source node to execute subsequent stages of the search in the event that the initial search fails to locate a node that supports the desired service.

In a progressive search process of the type described above, each of multiple stages of the progressive search may involve a given node broadcasting over a portion of the network a packet that contains a service location search message. Such a broadcast packet may include the following information:

1. An indicator that the packet contains a location search message.

2. The identity of the node that initiated the search.

3. The particular desired service.

4. The coverage area of the search.

It should be noted that the coverage area of the search is usually specific to the type of network. For example, in a DT network, the coverage area may be specified by a hop count limitation, which is included as part of the broadcast packet header. As another example, in a chord network, where nodes are arranged in the form of a ring, the coverage area may be specified as a particular portion of the ring. Numerous other types of networks and coverage area specification techniques may be used.

The coverage area may be determined at least in part based on general information known about the collective capabilities of the network nodes. Assume that a given node wants to search for a node that supports a particular service. In a DT network, a 3-hop search would typically cover about 20 to 30 nodes. If it is known that only 5% of the nodes support the particular service, a search over 25 nodes will have about a 73% chance of success, while a search over 50 nodes will have about a 90% chance of success. Accordingly, one can use this general knowledge about the network to set the coverage area to either 3 or 4 hops in order to obtain a desired chance of success.

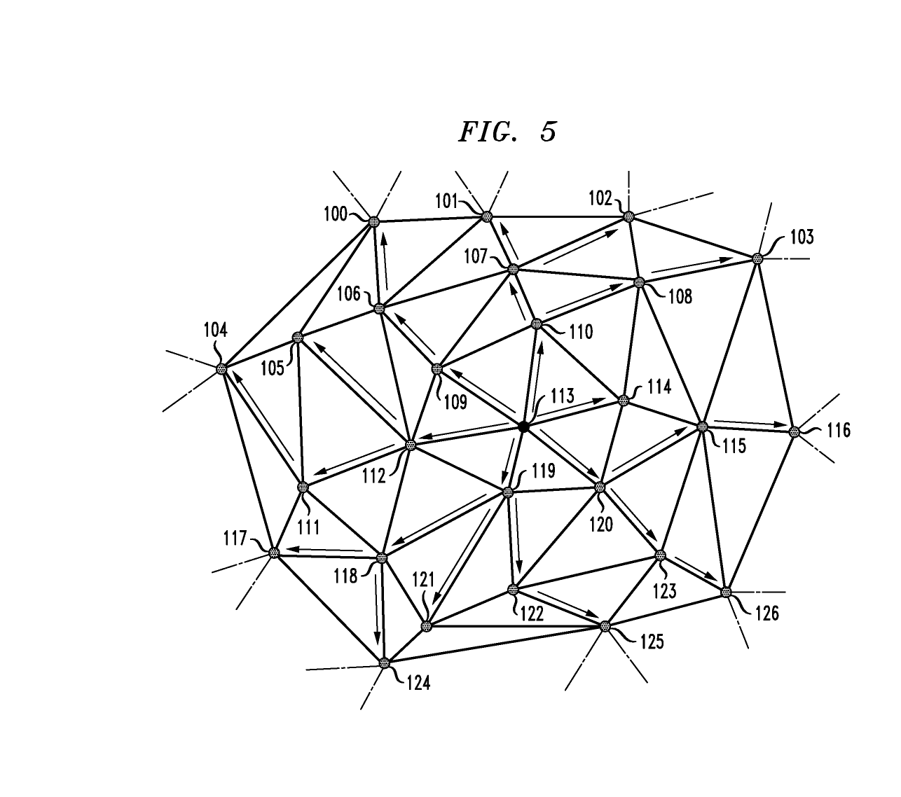

FIG. 5 shows an example of a 3-hop search in a DT network. The DT network in this example comprises nodes 100 through 126 interconnected as shown. The source node of the search in this example is node 113. Consider node 100. The search stops at node 100 as the broadcast packet has it takes 3 hops to reach node 100 from node 113. At node 100, the search could go on further if the hop count limitation was higher. As mentioned previously, nodes such as 100, 101, 102 and so on at which the hop count is reached from the source node are referred to herein as boundary nodes of the search.

It should be noted that a branch of the search may terminate at a given node prior to reaching the hop count if there are no further eligible downstream nodes for the given node. It is also possible that the hop count may be reached at such a terminating node. In any case, terminating nodes of this type are not considered boundary nodes in the context of the present example.

When a search is initiated, an excessive number of responses would be received by the source node if each node reached during the search were to send its response back to the source node. This is alleviated in the present embodiment by having each node send its response only to its immediate upstream node. If the response is a positive response, the upstream node will forward the response to the next upstream node, and so on until the forwarded response reaches the source node. If the response is a negative response, the upstream node will wait, up to a predetermined time limit, until it get responses from all the downstream nodes on respective search branches passing through that node and will then send a single consolidated negative response to the next upstream node.

This can be illustrated as follows with reference to the FIG. 5 example. In this example, nodes 101 and 102 will send their responses back to node 107. If both of the responses are negative responses, node 107 will combine them into a single consolidated negative response and send that response to its next upstream node, which is node 110. The fact that node 107 forwards the broadcast packet to nodes 101 and 102 implies that node 107 does not support the service that is being searched. Otherwise, node 107 would just send a positive response to node 110 and terminate the search process without forwarding the broadcast packet to nodes 101 and 102.

The above-described process ensures that the source node will only receive a single response, either a positive response or a consolidated negative response, from each of the search branches that emanate from that node. In the FIG. 5 example, this means that source node 113 will receive only a single response to its broadcast packet from each of its neighboring nodes 109, 110, 112, 114, 119 and 120.

Response processing of this type in the context of structured peer-to-peer networks and other types of networks can be found in U.S. Patent Application Publication No. 2011/0153634, entitled “Method and Apparatus for Locating Services within Peer-To-Peer Networks,” which is commonly assigned herewith and incorporated by reference herein. Certain of the techniques disclosed therein can be utilized at least in part in embodiments of the present invention.

In some embodiments, the response process as previously described is further modified in order to better support unstructured networks such as DT networks. More particularly, the nodes of the network shown in FIG. 5 are configured such that when a boundary node responds with a negative response indicating that it does not support the desired service, its response will include the identity of the boundary node. The identity may comprise at least a node identifier, also referred to herein as a node ID, and possibly other information. Such an arrangement allows the source node to eventually learn the identities of the boundary nodes, so as to facilitate implementation of one or more subsequent stages of a progressive search.

Assume that the 3-hop search illustrated in FIG. 5 does not locate any node that supports the desired service. This 3-hop search may be considered an initial stage of a progressive search that includes one or more additional stages. As part of this initial stage of the progressive search, assuming modified response processing at the boundary nodes as described above, the source node 113 would learn the identities of boundary nodes 101, 102 and 103 through the consolidated negative response from node 110, the identity of boundary node 116 through the consolidated negative response from node 120, and so on until source node 113 learns the identities of all the boundary nodes reached in the initial stage of the progressive search.

After the source node 113 receives all of the negative responses and thereby determines that no node supporting the desired service was located in the initial stage, it initiates a subsequent search stage over a different portion of the network. The subsequent search stage is carried out as follows. First, the source node 113 selects a particular subset of boundary nodes from the set of boundary nodes identified in the received responses of the initial stage. The source node 113 then sends to each of the boundary nodes in the subset a message in a unicast packet directing that boundary node to initiate an N-hop search for the desired service. The source node for each such N-hop search is still identified as the original requesting source node 113.

Each boundary node in the subset will complete its N-hop search and forward its response back to the source node 113. If the responses are negative, the source node 113 will learn the identities of additional boundary nodes. This information can be used in additional stages of the progressive search, until at least one positive response is received or the entire network is searched.

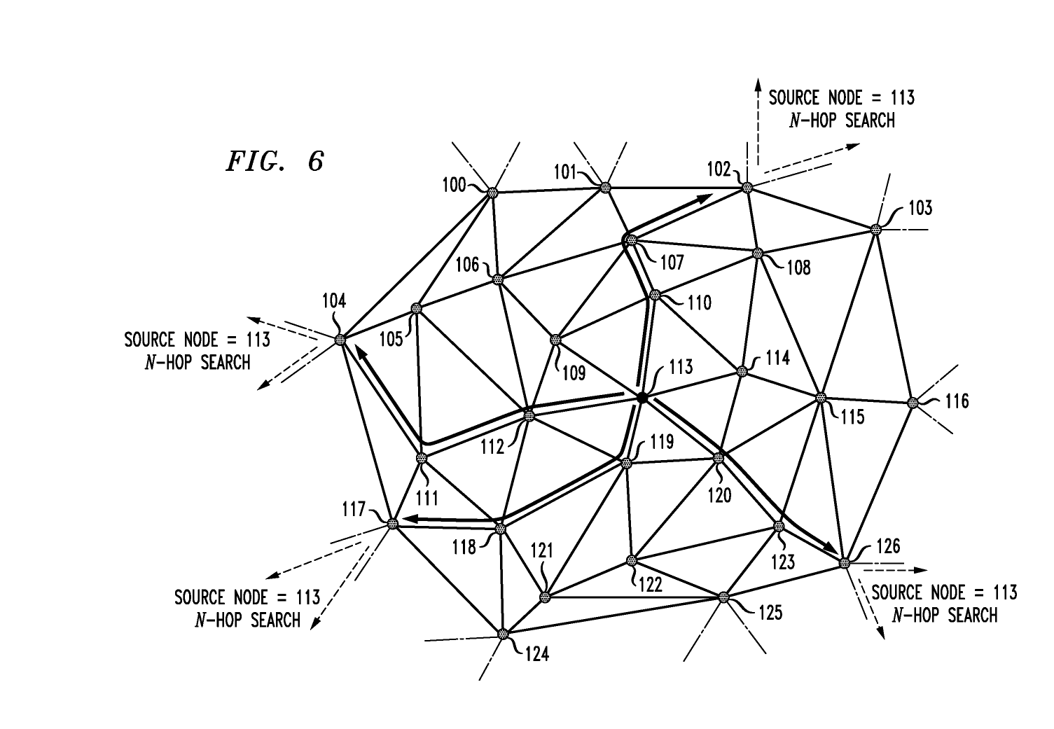

An example of a subsequent search stage using boundary nodes identified in an initial stage is illustrated in FIG. 6. After the 3-hop search of FIG. 5 fails to identify any node that supports the desired service, source node 113 initiates the next stage of the progressive search by identifying particular ones of the boundary nodes determined from the negative responses received in the initial stage. The subset of boundary nodes in this example includes boundary nodes 102, 104, 117 and 126. The source node 113 sends a unicast packet to each of these boundary nodes requesting the boundary node to initiate an N-hop search. For example, the source node may more particularly request that each such boundary node perform a 3-hop search. As indicated previously, node 113 is identified as the source node for each such boundary node search.

Although only a subset of the boundary nodes are requested to perform additional searching in this embodiment, in other embodiments all of the boundary nodes identified in the initial stage may be requested to perform additional searching in the next stage. Also, although each boundary node search has the same number of hops N in this example, the source node may instead direct different boundary nodes to perform searches using different numbers of hops.

The particular number of boundary nodes selected and the hop count for each boundary node search is determined in the FIG. 6 embodiment by the source node. This determination may be based, for example, on information such as network configuration and percentage of nodes that are known to provide the desired service. The provision of boundary node identity in negative responses as described above allows the source node to better direct its subsequent stages of progressive search, leading to increased search efficiency.

It should be noted that a given consolidated negative response in the embodiments described above typically contains identifiers of all the boundary nodes associated with a given search branch. However, if there are too many boundary nodes in the given search branch to be accommodated within message size constraints, it may be necessary to discard one or more of the boundary node identifiers. In order to minimize this, one may want to avoid executing searches with high hop counts. For example, the search hop counts may be limited to a specified fraction of the maximum number of boundary node identifiers that can be encoded in a message, such as one-half or one-third the maximum number of boundary node identifiers.

In certain types of networks, the reporting of boundary node identity in negative responses may not be needed. For example, in embodiments of the invention implemented in structured peer-to-peer networks, it will often be possible for the source node to execute efficient searches in subsequent stages of a progressive search based on the known geometry of the structured peer-to-peer network.

As an example, consider a peer-to-peer chord network. The nodes in the chord network are arranged in a ring topology. Let the addressing space of the chord network be 2⁴⁰. Without loss of generality, let the source node of a given progressive search be denoted as node 1. In this case, the first stage of the search can cover the address space from 1 to 2²⁰. If the first stage of the search fails to locate a node that supports the desired service, the source node can then search the address space between (2²⁰+1) and (2*2²⁰=2²¹) in a second stage. If the second stage of the search fails to locate a node that supports the desired service, the source node can then search the address space between (2²¹+1) and (4*2²¹=2²³) in a third stage, and so on until a positive response is received or the entire network is searched. Each node of the chord network can include a forwarding table that is defined such that searches over an address range can be executed efficiently, without requiring any knowledge of the boundary node identities. Additional details can be found in the above-cited U.S. Patent Application Publication No. 2011/0153634.

An illustrative embodiment of a network node will now be described in conjunction with FIG. 7. This network node may be viewed as representing a given node of any of the networks previously described in conjunction with FIGS. 1a through 6. Each node in a network may be configured in substantially the same manner, or different configurations may be used for different subsets of nodes. The exemplary node configuration of FIG. 7 may therefore be replicated for multiple nodes of a network. Numerous alternative node configurations may be used. Moreover, at least portions of a given node may be implemented at least in part in software using processor and memory components of an associated network device.

In this embodiment, network node 100 more particularly comprises a communication module 130 coupled to higher layers 132. The communication module 130 and higher layers 132 comprise respective processing layers of the node 100. It is assumed that the node 100 is a node of a DT network, although as indicated previously other embodiments of the invention can be implemented in other types of networks. The communication module 130 and higher layers 132 as illustrated in the figure may comprise components of a larger network device. However, the term “node” as used herein is intended to be broadly construed, and accordingly may comprise, for example, an entire network device or one or more components of a network device.

The communication module 130 of node 100 as illustrated further comprises a receive module 134, a packet discriminator 136, a transmit module 138, a unicast forwarding module 140 and a broadcast forwarding module 150 containing a reliable broadcast control module 160. The communication module 130 also comprises an additional module 170 for storing information relating to the neighbors of the node 100 as well as the neighbors of those neighbors. The information stored in the module 170 is collectively referred to as “neighbor information.”

Although FIG. 7 shows only a single receive link and a single transmit link for simplicity of illustration, the receive module 134 and transmit module 138 will more typically each have multiple links associated therewith. It is also possible that a given node may comprise multiple receive and transmit modules, each having multiple links associated therewith.

In operation, incoming packets are received at receive module 134 and are forwarded to the packet discriminator 136. Each such packet is assumed to comprise at least one header and at least one payload. The packet discriminator 136 classifies each of the received packets using information from its corresponding packet header.

If a received packet is a normal unicast packet, the packet discriminator checks whether the normal unicast packet is destined for this node or another node. If the normal unicast packet is destined for this node, the packet discriminator forwards the payload of the packet to the higher layers 132 (e.g., an application). If the normal unicast packet is destined for another node (e.g., a transit packet), the packet discriminator forwards the packet to the unicast forwarding module 140. The unicast forwarding module will then forward the packet to its destination, through the transmit module 138, based on the neighbor information stored in the module 170.

If a received packet is a broadcast packet, packet discriminator 136 performs the following functions:

1. Determines whether the node has received this broadcast packet before. If the node has already received the packet, the packet is immediately discarded and no further action is taken. This assumes that the node stores a copy of each received broadcast packet. If the node has not received the broadcast packet before, the packet discriminator 136 proceeds as described below. A maximum time may be established for storing received broadcast packets, in order to avoid overflowing node memory. For example, each received broadcast packet may be stored for up to a predetermined time limit, at which point the packet may be discarded.

2. Forwards a copy of the packet payload to the higher layers 132.

3. Checks whether a reliable broadcast indicator in the broadcast packet header is set to TRUE. If the indicator is set to TRUE, a positive acknowledgement is generated for delivery back to the upstream node. The positive acknowledgment is forwarded to the unicast forwarding module 140, which will forward a corresponding unicast packet to the upstream node of the incoming broadcast packet.

4. Checks the hop count of the broadcast packet. If the hop count is 0, the broadcast packet is discarded. If the hop count is not 0, the hop count is decremented by 1 and then the packet is forwarded to the broadcast forwarding module 150, which will manage the process of forwarding broadcast packets.

If a received packet is a broadcast packet encapsulated in a unicast packet, packet discriminator 136 first de-encapsulates the broadcast packet, and then processes the broadcast packet in the manner described above. This may involve forwarding the received broadcast packet, with any appropriate header modifications, to one or more additional nodes. For example, node 101 in the FIG. 4 embodiment receives a unicast packet comprising an encapsulated broadcast packet sent by node 103. Node 101 will de-encapsulate the encapsulated broadcast packet and forward the broadcast packet downstream. It will also forward at least the broadcast packet to node 100. Accordingly, node 101 may forward the unicast packet to node 100 or alternatively may forward the de-encapsulated broadcast packet to node 100. Again, such forwarding, and other forwarding described herein, may involve modification of header information. The term “forwarding” as used herein is therefore intended to be broadly construed.

If a received packet is a control packet from a neighbor which contains information about its neighbors, that information is used to update the neighbor information in module 170.

If a received packet is a positive acknowledgement packet for a reliable broadcast message from a neighbor, information stored in reliable broadcast control module 160 will be updated. The manner in which this information is utilized will be described in greater detail below.

If an application implemented in the higher layers 132 wants to send a unicast packet, the application forwards the packet to unicast forwarding module 140.

If an application implemented in the higher layers 132 wants to send a broadcast packet, the application forwards the packet to broadcast forwarding module 150. In addition to the packet itself, the application may also pass along information such as a hop count limitation for the packet, and whether or not reliable broadcast checking is to be used for the packet.

The reliable broadcast control module 160 implements reliable broadcast checking functionality in the node 100. If reliable broadcast checking is to be used for a given broadcast packet, the module 160 will set the reliable broadcast indicator in the packet header to TRUE when the broadcast packet originates from the node 100. For transit broadcast packets, this indicator has already been set by another node.

When broadcast forwarding module 150 forwards a packet to the appropriate neighbors, as determined from neighbor information in module 170, the reliable broadcast control module 160 will keep a copy of the packet as well as a list of the neighbors to which the packet has been forwarded. It then starts a timer. When the node receives a positive response for this packet from one of the recipient neighbors, the module 160 will remove that neighbor from the list. If the list of recipient neighbors becomes empty, this signifies that all the recipient neighbors have received the broadcast packet. The module 160 then stops the timer and removes the packet from memory as the packet has been delivered successfully to all downstream recipients.

If the timer expires and the recipient list is not empty, the reliable broadcast control module 160 will resend the broadcast packet to all the neighbors in the recipient list and restart the timer. The module 160 will attempt to resend the packet to a given node a specified number of times. If after the specified number of times the message is still not delivered, the module 160 will use the above-described recovery process to propagate the broadcast packet. As mentioned previously, this typically involves encapsulating the broadcast packet within a special delivery unicast packet that is sent to one or more downstream neighbors of the unreachable node. Other types of recovery processes may be used in other embodiments.

Although certain illustrative embodiments are described herein in the context of DT networks, other types of networks can be used in other embodiments. As noted above, a given such network may comprise, for example, a machine-to-machine network, sensor network or other type of network comprising a large number of relatively low complexity nodes. However, the disclosed techniques may also be applied to a wide area computer network such as the Internet, a metropolitan area network, a local area network, a cable network, a telephone network or a satellite network, as well as portions or combinations of these or other networks. The term “network” as used herein is therefore intended to be broadly construed.

As mentioned above, a given network node may be implemented in the form of a network device comprising a processor, a memory and a network interface. Numerous alternative network device configurations may be used.

The processor of such a network device may be implemented utilizing a microprocessor, a microcontroller, an application-specific integrated circuit (ASIC), a field-programmable gate array (FPGA), or other type of processing circuitry, as well as portions or combinations of such processing circuitry. The processor may include one or more embedded memories as internal memories.

The processor and any associated internal or external memory may be used in storage and execution of one or more software programs for controlling the operation of the network device. Accordingly, one or more of the modules 134, 136, 138, 140, 150, 160 and 170 of node 100 in FIG. 7 or portions thereof may therefore be implemented at least in part using such software programs.

The memory of the network device is assumed to include one or more storage areas that may be utilized for program code storage. The memory may therefore be viewed as an example of what is more generally referred to herein as a computer program product or still more generally as a computer-readable storage medium that has executable program code embodied therein. Other examples of computer-readable storage media may include disks or other types of magnetic or optical media, in any combination. The memory may therefore comprise, for example, an electronic random access memory (RAM) such as static RAM (SRAM), dynamic RAM (DRAM) or other types of electronic memory. The term “memory” as used herein is intended to be broadly construed, and may additionally or alternatively encompass, for example, a read-only memory (ROM), a disk-based memory, or other type of storage device, as well as portions or combinations of such devices.

The memory may additionally or alternatively comprise storage areas utilized to provide input and output packet buffers for the network device. For example, the memory may implement an input packet buffer comprising a plurality of queues for storing received packets to be processed by the communication module 130 of the node 100 and an output packet buffer comprising a plurality of queues for storing processed packets to be transmitted by the communication module 130.

It should be noted that the term “packet” as used herein is intended to be broadly construed, so as to encompass, for example, a wide variety of different types of protocol data units, where a given protocol data unit may comprise at least one payload as well as additional information such as one or more headers. Packets may incorporate or otherwise comprise a wide variety of different types of messages that may be exchanged between nodes in conjunction with execution of processes as disclosed herein.

Also, the term “broadcast packet” as used herein is intended to be broadly construed, and may encompass, for example, a multicast packet.

The network interface of the network device may comprise transceivers or other types of network interface circuitry configured to allow the network device to communicate with the other network devices of the communication network. As mentioned above, each such network device may implement a separate node of the communication network.

The processor, memory, network interface and other components of the network device implementing a given node may include well-known conventional circuitry suitably modified to implement at least a portion of the enhanced broadcasting functionality described above. Conventional aspects of such circuitry are well known to those skilled in the art and therefore will not be described in detail herein.

It is to be appreciated that a given node or associated network device as disclosed herein may be implemented using additional or alternative components and modules other than those specifically shown in the exemplary arrangement of FIG. 7.

As mentioned above, embodiments of the present invention may be implemented at least in part in the form of one or more software programs that are stored in a memory or other computer-readable storage medium of a network device or other processing device of a communication network. As an example, network device components such as portions of the communication module 130 and higher layers 132 may be implemented at least in part using one or more software programs.

Numerous alternative arrangements of hardware, software or firmware in any combination may be utilized in implementing these and other system elements in accordance with the invention. For example, embodiments of the present invention may be implemented in one or more ASICS, FPGAs or other types of integrated circuit devices, in any combination. Such integrated circuit devices, as well as portions or combinations thereof, are examples of “circuitry” as that term is used herein.

It should again be emphasized that the embodiments described above are for purposes of illustration only, and should not be interpreted as limiting in any way. Other embodiments may use different types of network, node and module configurations, and alternative processes for implementing functionality such as hop level acknowledgment, failure recovery and progressive search. Also, it should be understood that the particular assumptions made in the context of describing the illustrative embodiments should not be construed as requirements of the invention. The invention can be implemented in other embodiments in which these particular assumptions do not apply. These and numerous other alternative embodiments within the scope of the appended claims will be readily apparent to those skilled in the art.

What is claimed is:

1. An apparatus comprising:
a first node adapted for communication with a plurality of additional nodes of a communication network;
wherein the first node is configured to detect a failure in delivery of a broadcast packet to at least a given one of the additional nodes; and
wherein responsive to the detected failure in delivery of the broadcast packet to the given additional node, the first node encapsulates the broadcast packet in a unicast packet for delivery to another one of the additional nodes that is a downstream node of the given additional node.

2. The apparatus of claim 1 wherein the first node is configured to detect the failure in delivery of the broadcast packet to the given additional node using a hop level acknowledgment process.

3. The apparatus of claim 2 wherein in conjunction with the hop level acknowledgement process, the first node sends the broadcast packet to the given additional node, starts a timer and waits for an acknowledgment from the given additional node, and wherein if the timer expires before an acknowledgement is received, the first node resends the broadcast packet to the given additional node, restarts the timer and waits for an acknowledgement from the given additional node, and further wherein the failure in delivery of the broadcast packet is detected after the broadcast packet has been sent to the given additional node a designated number of times without receiving acknowledgement within the time period defined by the timer.

4. The apparatus of claim 1 wherein the broadcast packet comprises a header that includes a hop level acknowledgement indicator.

5. The apparatus of claim 4 wherein the hop level acknowledgment indicator of the broadcast packet header comprises a binary indicator having a first value indicating that hop level acknowledgment is activated for the broadcast packet and a second value indicating that hop level acknowledgment is not activated for the broadcast packet.

6. The apparatus of claim 1 wherein the first node is configured to maintain neighbor information identifying each of the additional nodes that is a neighbor of the first node as well as each of the additional nodes that is a neighbor of one of the neighbors of the first node.

7. The apparatus of claim 6 wherein responsive to the detected failure in delivery of the broadcast packet to the given additional node, the first node utilizes the neighbor information to identify all of the neighbors of the given additional node that are not also a neighbor of the first node and are further away from a source node of the broadcast packet than the given additional node, and sends to each of the identified nodes the broadcast packet encapsulated in a unicast packet.

8. The apparatus of claim 1 wherein the first node is further configured such that if the first node receives from one of the additional nodes that is an upstream node of the first node an upstream node a broadcast packet associated with a search and having a hop count indicating that a hop count limitation has been reached, the first node generates a response for delivery back to the upstream node that includes information identifying the first node as a boundary node of the search.

9. A network device comprising the apparatus of claim 1.

10. A communication network comprising:
a first node; and
a plurality of additional nodes;
wherein the first node is configured to detect a failure in delivery of a broadcast packet to at least a given one of the additional nodes; and
wherein responsive to the detected failure in delivery of the broadcast packet to the given additional node, the first node encapsulates the broadcast packet in a unicast packet for delivery to another one of the additional nodes that is a downstream node of the given additional node.

11. The network of claim 10 wherein the communication network comprises a Delaunay Triangulation (DT) network.

12. The network of claim 10 wherein the downstream node upon receipt of the unicast packet de-encapsulates the broadcast packet from the unicast packet and forwards the broadcast packet to at least one other additional node.

13. The network of claim 10 wherein the downstream node upon receipt of the unicast packet forwards the unicast packet to at least one other additional node.

14. A method comprising:
detecting in a first node of a communication network a failure in delivery of a broadcast packet to at least a given one of a plurality of additional nodes of the communication network; and
responsive to the detected failure in delivery of the broadcast packet to the given additional node, encapsulating the broadcast packet in a unicast packet for delivery to another one of the additional nodes that is a downstream node of the given additional node.

15. The method of claim 14 further comprising sending the unicast packet to the downstream node of the given additional node.

16. The method of claim 14 further comprising detecting the failure in delivery of the broadcast packet to the given additional node using a hop level acknowledgment process.

17. The method of claim 14 further comprising the step of including in a header of the broadcast packet a hop level acknowledgement indicator.

18. The method of claim 14 further comprising the steps of:
receiving in the first node from one of the additional nodes that is an upstream node of the first node a broadcast packet associated with a search and having a hop count indicating that a hop count limitation has been reached; and
generating a response for delivery back to the upstream node that includes information identifying the first node as a boundary node of the search.

19. The method of claim 14 further comprising the steps of:
receiving in the downstream node the unicast packet comprising the encapsulated broadcast packet;
de-encapsulating the broadcast packet from the unicast packet; and
forwarding the broadcast packet to at least one other additional node.

20. The method of claim 14 further comprising the step of:
receiving in the downstream node the unicast packet comprising the encapsulated broadcast packet; and
forwarding the unicast packet to at least one other additional node.

21. An article of manufacture comprising a computer-readable storage medium having embodied therein executable program code that when executed by a network device associated with the first node causes the first node to perform the method of claim 14.

22. An apparatus comprising:
a first node adapted for communication with a plurality of additional nodes of a communication network;
wherein the first node is configured such that if the first node receives from one of the additional nodes that is an upstream node of the first node an upstream node a broadcast packet associated with a search and having a hop count indicating that a hop count limitation has been reached, the first node generates a response for delivery back to the upstream node that includes information identifying the first node as a boundary node of the search.

23. The apparatus of claim 22 wherein the response comprises a unicast packet having as its destination a source node of the search.

24. A method comprising:
receiving in the first node of a communication network from one of a plurality of additional nodes of the communication network that is an upstream node of the first node a broadcast packet associated with a search and having a hop count indicating that a hop count limitation has been reached; and
generating a response for delivery back to the upstream node that includes information identifying the first node as a boundary node of the search.
